(19) United States
(12) Patent Application Publication
(10) Pub. No.: US 2018/0189836 A1
(43) Pub. Date: Jul. 5, 2018

(54) CAMPAIGN DELIVERY SYSTEM

(71) Applicant: INTERNATIONAL BUSINESS MACHINES CORPORATION, ARMONK, NY (US)

(72) Inventors: Anurag Srivastava, Pune (IN); Dhanashree Srivastava, Pune (IN)

(21) Appl. No.: 15/398,141

(22) Filed: Jan. 4, 2017

(51) Int. Cl. G06Q 30/02

(52) U.S. Cl. CPC G06Q 30/0264

(57) ABSTRACT

Systems, methods and tools for targeting campaign notifications during specific times that a user performs related activities or events. The targeted delivery system retrieves information describing the user's day to day activities and the timing of the activities from a plurality of data sources such as social media, browser history, downloads, search engine activity, emails, audio data, video data etc. From the collection of activity data, a schedule may be created that may segment each different activity or proclivity into a particular time slot where a pattern of an activity or proclivity generally occurs. The targeted campaign delivery systems identify a user's schedule and lifestyle, breaks down the schedule into a series of time slots and caters the delivery of context specific campaign notifications before, during or closely after the time frames when the relevant activities are typically scheduled to occur.

### TECHNICAL FIELD

The present disclosure relates generally to systems, methods and tools for delivering and displaying campaign notifications.

### BACKGROUND

A number of online advertising systems exist for displaying targeted notifications, such as advertisements on web pages. To advertise via such a system, a person associated with the business typically interacts with a series of web pages of the advertising system to set up one or more ad campaigns. During this process, the person typically specifies the text to be included in a particular ad, the URL of a target or “landing” page, ad targeting information for selecting the ad for display (e.g., one or more keywords or keyword phrases), and pricing information that governs how much the business/advertiser will be charged in connection with ad “click-thru” events. The business/advertiser can also typically specify one or more parameters, such as a daily budget and a campaign termination date, for controlling the timing and frequency with which a given ad is displayed.

Once an ad campaign has been created, the advertising system automatically selects the ad for display on the web pages of one or more web sites, and (typically) charges the advertiser for each resulting ad click-thru event. The particular method used by the advertising system to select ads for display may vary widely. For example, in the case of a search request from a user, the advertising system may present the ads of advertisers that have associated their respective ads with a search term or phrase entered by the user. In the case of a request for a relatively static web page, the advertising system may present those ads deemed to be the most closely related to page's textual content.

### SUMMARY

A first embodiment of the present disclosure provides a method delivering targeted campaign notifications to a computer system comprising the steps of: analyzing, by a processor of the computer system, user activity information received from a plurality of data sources; compiling, by the processor, as a function of the analyzing step, a schedule organized into discrete time slots, wherein each of the time slots are categorized with a corresponding metadata tag describing properties of each of the time slots; transmitting, by the processor, the schedule to a campaign management system; receiving, by the processor, a campaign notification transmitted during a time slot of the schedule, wherein content of the campaign notification is selected by the campaign management system to match the metadata tag describing the properties of the time slot; and displaying, by the processor, a graphical representation of the campaign notification during the time slot.

A second embodiment of the present disclosure provides a computer system, comprising: a central processing unit (CPU); a memory device coupled to the CPU; and a computer readable storage device coupled to the processor, wherein the storage device contains program code executable by the CPU via the memory device to implement a method for delivering targeted campaign notifications to the computer system comprising the steps of: analyzing, by the CPU, user activity information received from a plurality of data sources; compiling, by the CPU, as a function of the analyzing step, a schedule organized into discrete time slots, wherein each of the time slots are categorized with a corresponding metadata tag describing properties of each of the time slots; transmitting, by the CPU, the schedule to a campaign management system; receiving, by the CPU, a campaign notification transmitted during a time slot of the schedule, wherein content of the campaign notification is selected by the campaign management system to match the metadata tag describing the properties of the time slot; and displaying, by the CPU, a graphical representation of the campaign notification during the time slot.

A third embodiment of the present disclosure provides a computer program product comprising: one or more computer readable hardware storage devices having computer readable program code stored therein, said program code containing instructions executable by the one or more central processing units (CPU) to implement a method for delivering targeted campaign notifications to a computer system comprising the steps of: analyzing, by the CPU, user activity information received from a plurality of data sources; compiling, by the CPU, as a function of the analyzing step, a schedule organized into discrete time slots, wherein each of the time slots are categorized with a corresponding metadata tag describing properties of each of the time slots; transmitting, by the CPU, the schedule data 209 to a campaign management system; receiving, by the CPU, an campaign notification transmitted during a time slot of the schedule, wherein content of the campaign notification is selected by the campaign management system to match the metadata tag describing the properties of the time slot; and displaying, by the CPU, a graphical representation of the campaign notification during the time slot.

### BRIEF DESCRIPTION OF THE DRAWINGS

FIG. 1 depicts a schematic view of embodiment of a system for delivering targeted campaign notifications consistent with the embodiments of the present disclosure.

FIG. 2a depicts an embodiment of a flow chart describing a system for delivering targeted campaign notifications.

FIG. 2b depicts an alternative embodiment of a flow chart describing a system for delivering targeted campaign notifications.

FIG. 3 depicts a flow chart describing an embodiment of a method for delivering targeted campaign notifications.

FIG. 4 depicts a block diagram of an embodiment of a generic computer system capable of implementing methods for delivering targeted campaign notifications consistent with the embodiments described in this application.

### DETAILED DESCRIPTION

### Overview

Embodiments of the present disclosure recognize that currently available campaign delivery systems pushing notifications to users and potential clients do not target the users' when they may be most receptive to receiving specific types of campaign notifications and content. Generally, a campaign messaging system may identify information about the user and instead of targeting the specific notifications to the user at specific times when the notification may be more relevant, the campaign systems will deliver generic or user relevant campaign notifications regardless of the current time or activity currently being performed by the user. Delivering the messages and notifications at the wrong times, inconvenient times or during activities performed by the user that are not relevant to the campaign notifications can be a wasteful use of computing resources due to the notifications being mostly ignored users.

Embodiments of the present disclosure solve the problems incurred by currently available campaign delivery systems. Embodiments of the present disclosure may target campaign notifications during specific times that a user performs related activities or within a particular time frame where a user may have the most likely amount of interest in receiving the targeted campaign notifications. Instead of merely identifying relevant information about the user being targeted by a campaign system and generically delivering related campaign notification at any possible time, the targeted campaign delivery systems of the present disclosure identify a user's schedule and lifestyle. The campaign deliver system may break down the schedule into a series of time slots. Each time slot may be identified as being dedicated to a particular activity, an association with particular people, a location or by keywords such as free time, work, commute, leisure time, etc. Systems of the current disclosure may cater the delivery of context specific campaign notifications before, during or closely after the time frames when the relevant activities are typically scheduled to occur.

By targeting specifically relevant time slots of the notification recipients, improvements in the efficiency of the campaign system itself may be realized. The campaign system may accurately deliver relevant notifications that become more noticeable to the recipient, reducing wasted notifications and increasing the likelihood of users seeking out the goods, services or promotions being promoted in the notifications. Instead of wasting computing resources to constantly bombard users with notifications at all hours of the day, the campaign system may improve the operation of campaign computer system and the efficiency of the hardware resource consumption by selectively targeting campaign notifications and only during relevant time slots.

Embodiments of the targeted delivery system of the present disclosure may retrieve information describing the user's day to day activities and the timing of the activities from a plurality of data sources such as social media, browser history, downloads, search engine activity, web application, emails, short messaging services (SMS), direct messaging service data, audio data, video data etc. From the collection of the activity data, a schedule may be created that may segment each different activity or proclivity of the user into a particular time slot where a pattern of an activity or proclivity generally occurs. For example, the system may identify that “Monday through Friday the user drives to work around 7 to 7:30 am and turns on music for the drive.” The system may target the commute to work and deliver campaign notifications related to this activity or activities tangentially related thereto. For instance, notifications may include weather or traffic information, available music streaming services, podcast services, books on tape, upcoming concerts for the type of music listened to by the user, mechanics or vehicle repair services, car dealership notifications, etc.

Embodiments of the targeted delivery system may further tag or categorize the segmented time slots of the daily schedule with keywords and other metadata to further improve the efficiency of the system to identify the appropriate notifications for each time slot of the user's schedule. The tags or categorizations may include descriptions for the activities or proclivities occurring during the time slot. The tags or categorization may also describe the location, the presence of other individuals, or even the lack of activity that may be occurring (i.e. free time). In some embodiments, the targeted delivery system may analyze the tagged or categorized time slots of the schedule and compare each of the time slot tags with a database of tagged campaign notifications. Embodiments of the targeted delivery system may correlate the tagged time slot to one or more similarly tagged campaign notifications and deliver the contents of the tagged campaign notification to the user during the targeted time slot. For example, the system may identify that 5 pm-6 pm on weekdays the user enjoys meeting up with friends after work. The campaign system may deliver notifications that may be tagged for leisure time or social gatherings. For instance, the database may provide notifications tagged for delivery during social activities such as recommendations for upcoming concerts, movies, restaurants and sporting events. Therefore, because the notifications are generally related to social activities and the notifications are delivered during a social activity, there may be an increased probability that the campaign notification may be noticed and/or resonate with the recipient user to complete the promotion being transmitted to the user.

### System for Delivering Targeted Campaign Notifications

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

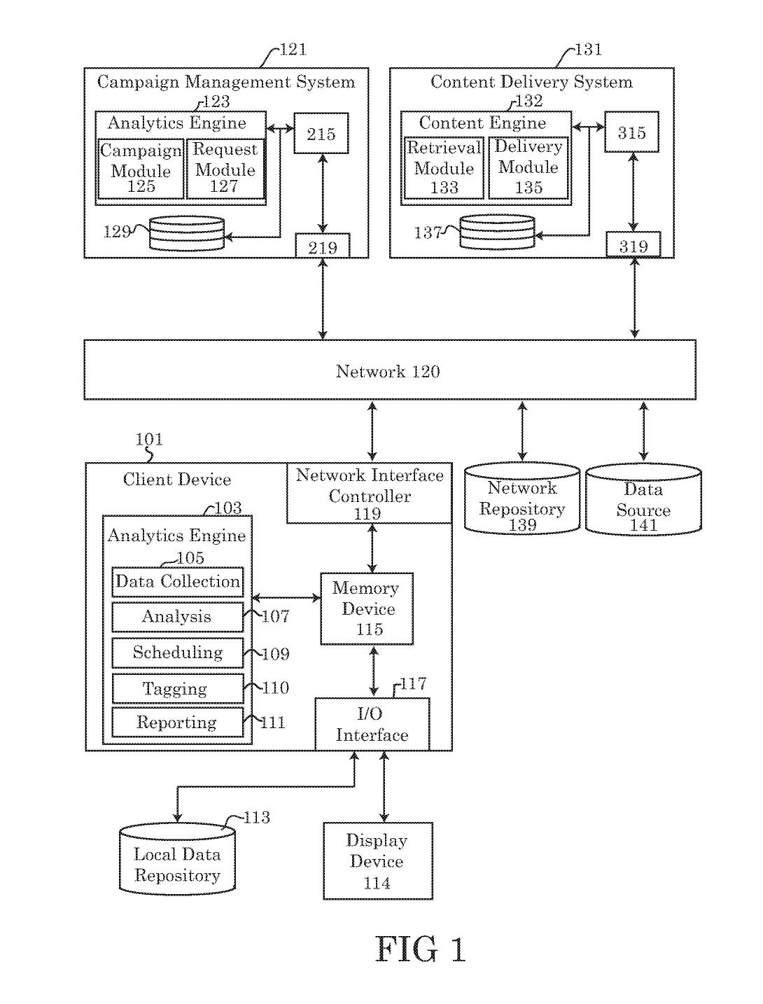

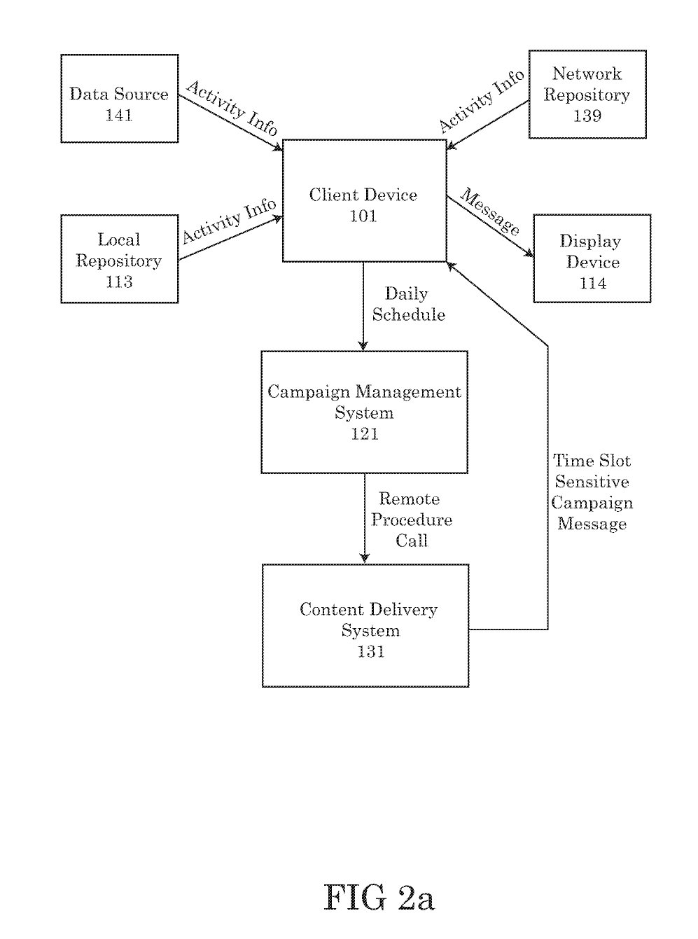

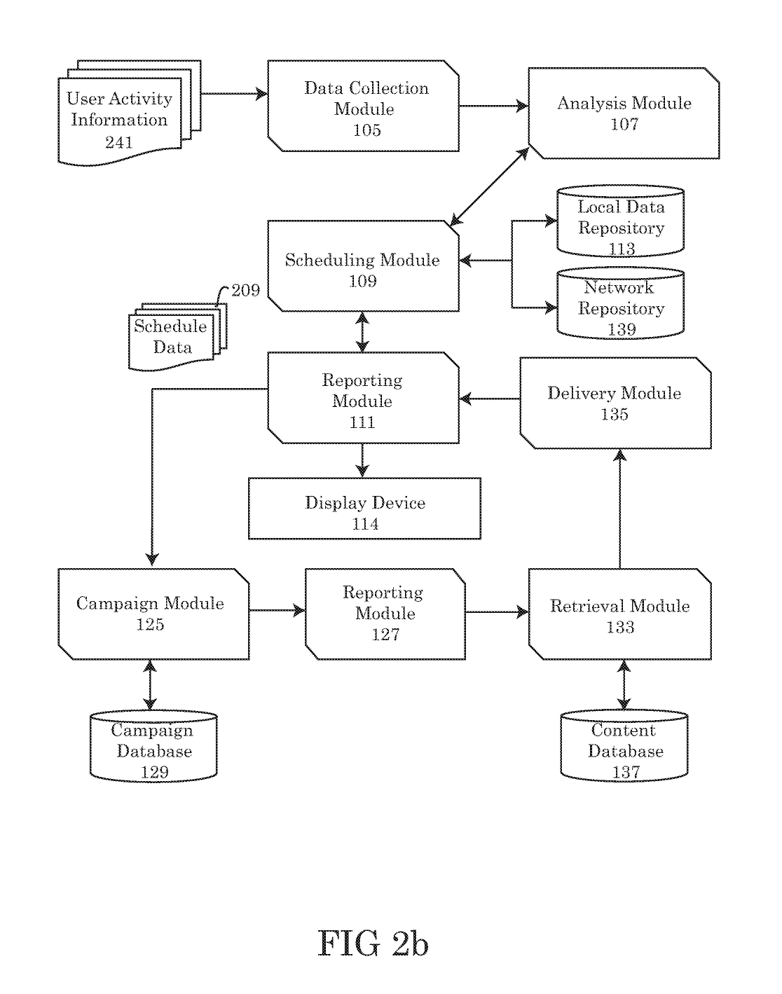

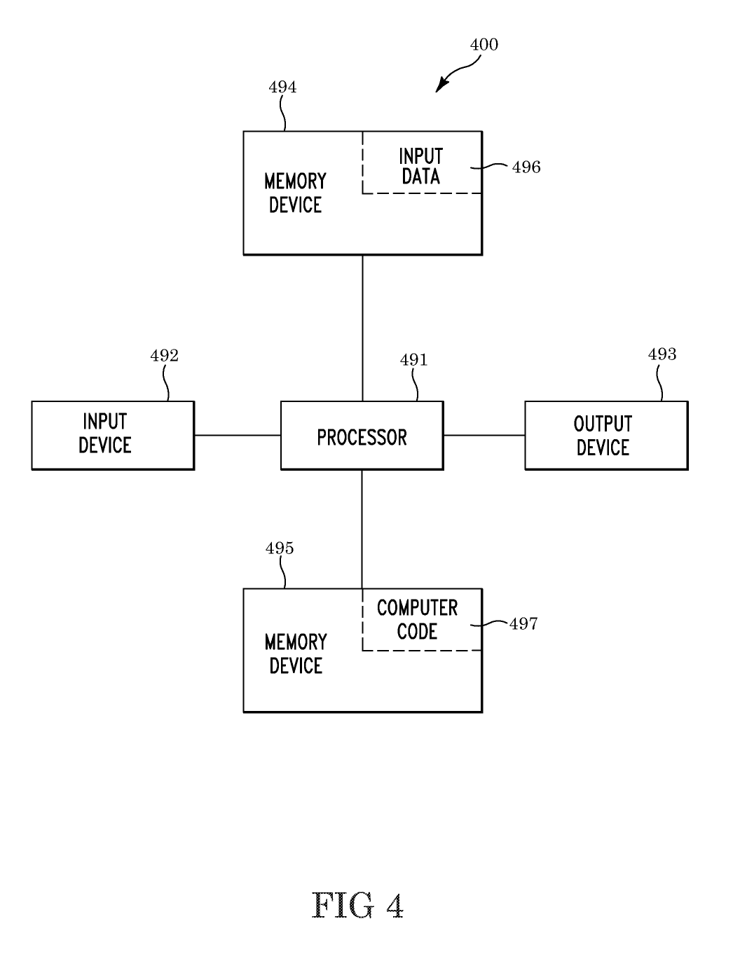

Referring to the drawings, FIG. 1 depicts a block diagram of a targeted notification delivery system 100 for delivering targeted campaign notifications to one or more campaign notification recipients. Embodiments of the targeted delivery system 100 may comprise one or more computer systems 101, 121, 131. Each of the computer systems 101, 121, 131 may be a specialized computer system, having specialized configurations of hardware, software or a combination thereof as depicted in FIG. 1-2 of the present disclosure and in some of the embodiments described herein. Embodiments of the computer systems 101, 121, 131 may comprise not only the elements depicted in FIG. 1-2, but may also incorporate one or more elements of a generic computer system 400 as depicted in FIG. 4 (described in detail below). Elements of the generic computer system 400 of FIG. 4, may be integrated into the specialized computer systems 101, 121, 131 of FIGS. 1-2.

In some embodiments, the client device 101 of the targeted delivery system 100 may include an analytics engine 103. The analytics engine 103 may discover, interpret and communicate meaningful patterns in data received by the client device 101. The analytics engine 103 may utilize simultaneous applications of statistics, computer programming and in some instances data visualization to perform a computational analysis of data. Moreover, the embodiments of the analytics engine may utilize a combination of predictive analytics and web analytics to analyze historical data retrieved from one or more data sources to identify trends in the data as well as meaningful patterns of a particular user's behavior and routines. The analytics engine 103 may analyze the effects of user generated decisions, activities, messaging, applications (such as calendars and reminder applications), interactions with the client device 101 and/or real life events to gain knowledge about the user, the user's schedule, the user's interests and improve the functionality of the targeted delivery system 100 to deliver campaign notifications to the user's client device 101 at a relevant time to provide information relevant to the user's daily routine.

Embodiments of the system 100 may utilize the functionality of the analytics engine 103 to learn and identify patterns in the behavior and routines of the user of the client device 101. The conclusions and patterns identified by the analytics engine 103 may create a foundation for recognizing and delivering campaign notifications to the user at precise time slots and thus may offer an opportune moment for the campaign management system 121 to maximize the exposure of the campaign notifications being transmitted to the client device 101. The maximization of attention to the campaign notifications being delivered at a particular time slot may be in part due to the relevancy of the campaign notification being delivered at the particular moment (i.e. the campaign notification is relevant to the events occurring in the user's life when the campaign notification is delivered) or during moments identified by the system 100 that may provide the user the opportunity to engage with the notifications uninterrupted (i.e. during leisure time).

Embodiments of the analytics engine 103 may be integrated into the client device (as either hardware or software), or in some embodiments, the analytics engine 103 may be accessible over the network 120 via a cloud computing network or other network accessible hardware communicating with the client device 101. In some embodiments, the analytics engine 103 may be virtualized on the client device 101 via remotely accessible hardware and/or software applications.

Embodiments of the analytics engine 103 may include one or more modules. As shown in FIG. 1, the modules of the analytics engine 103 may include a data collection module 105, an analysis module 107, a scheduling module 109, a tagging module 110 and a reporting module 111. The term “module” may refer to a hardware based module, software based module or a module may be a combination of hardware and software resources. A module (whether hardware, software, or a combination thereof) may be designed to implement or execute one or more particular functions, tasks or routines. Embodiments of hardware based modules may include self-contained components such as chipsets, specialized circuitry and one or more memory devices. A software-based module may be part of a program code or linked to program code containing specific programmed instructions loaded in the memory device 115 of the client device 101 or a remotely accessible memory device 215, 315 of another computer system 121, 131 of the network 120.

The data collection module 105 may collect and retrieve user activity information 241 in the form of data or data sets from a plurality of data sources 141, data marts, knowledge bases, and repositories 113, 139. User activity information 241 may refer to data that may describe events, routines, activities, proclivities, general interests, hobbies, etc. that may be learned about a user from the data collected by the data collection module 105. The user activity information 241 may be collected from locally accessible sources such as a local data repository 113 connected to the input/output interface 117 of the client device. The user activity information 241 may also be collected from network accessible sources, such as a network accessible repository 139. The data repositories113, 139 may include descriptive data generated as a function of the user's activity and interaction with client device 101 and/or interaction with network accessible data sources 141. The user activity information 241 collected by the data collection module 105 may include but is not limited to key strokes, mouse movements, video data or audio data from an audio and/or video input device (e.g. camera or microphone), internet browsing history data, search engine history data, data generated through the use of applications or web applications such as a calendar or reminder application, social media data, direct messaging service data, SMS data, mobile communications, calendar application, phone messaging services, VOIP, email, computer logs, computer files, network logs, and any other sources of data that may be known by a person skilled in the art.

Embodiments of the data collection module 105 may continuously collect or periodically scrape data from each of the accessible data sources 141 and data repositories 113, 139 described above. As the amount of data collected by the data collection module 105 increases, more accurate predictions and conclusions may be drawn by the analytics engine 103. The incorporation of new user activity information 241 into the analysis module 107 may assist the analytics engine 103 by allowing the analytics engine 103 to more accurately predict particular events, routines, activities, the people that may be involved with or engaged with the user's activity and more accurately gauge each of the time slots in which the activities and events may occur.

In some embodiments of the analytics engine 103, the analytics engine 103 may include an analysis module 107. The analysis module 107 may be the hardware and/or software component of the analytics engine 103 that may be capable of analyzing the data collected by the data collection module 105. Using the data collected by the data collection module 105, the analysis module 107 may identify a plurality of time slots, activities, events, occurrences, and/or patterns of behavior of the user and the appropriate periods of time allotted to each of the activities in a particular time slot. For example, data collected by the data collection module, the analysis module 107 may identify differing patterns during the standard work week (approximately Monday to Friday, 9 am to 5 pm), patterns occurring before working hours, patterns occurring after working hours, and patterns on non-working days. The analysis module 107 may segment each of the user's days into identifiable sections that occur within a particular time slot. The sections of activities/events occurring may have a common theme, event, occurrence or activity being performed.

In some embodiments of the analytics engine 103, the analytics engine 103 may include a scheduling module 109. The scheduling module may be responsible for performing the task of re-creating a daily schedule of the user based on the analysis performed by the analysis module 107. The scheduling module 109 may organize each of the activities, events, occurrences and patterns identified by the analysis module 107, into distinct segmented time slot. The scheduling module 109 may link the particular activity, event or conclusion drawn by the analysis module 107 to each of the time slots thus segmenting the schedule into distinct and separate sections of interest allowing for a marketing campaign to deliver a targeted notification to the user within the particular time slot. Table 1 below provides an additional example of an entry made by a scheduling module 109 depicting an example of a schedule segmented by time slots, the patterns of behaviors attributed to the user, some examples of associated keywords for the time slot and an example of offer types that may be associated with the activity or keywords.

TABLE 1

| Time | | | |
|---|---|---|---|
| Slot | Activity or Event | Keywords | Offer types |
| 7am-8am | On mobile phone, | Phone, messaging, | Electronics, |
| | check messages, | internet, | household items |
| | browsing internet | entertainment, | |
| | | home | |
| 8am-9am | Commuting | Driving, | Vehicle related, |
| | to work | vehicles, | vehicle repair, |
| | via vehicle | music, radio | music, audiobooks, |
| | | | podcasts |
| 9am-6pm | Work - little | Work, inattentive, | N/A |
| | phone or | busy | |
| | message activity | | |
| 12pm-1pm | Lunch - with | Social, sports, | Sports tickets, |
| | friends/coworkers | entertainment, | television/movies, |
| | | current events | concerts, news |
| 6pm-7pm | Commute home | Driving, home, | Vehicle related, |
| | | vehicles, | vehicle repair, |
| | | music, radio | music, audiobooks, |
| | | | podcasts, household |
| | | | items |
| 7pm-8pm | Social activities | Social, family, | Sports, |
| | and leisure | free time, | television/movies, |
| | time with family | internet, | concerts, news, |
| | | entertainment | vacations |

In some embodiments, the scheduling module 109 may further categorize and/or add descriptors to each of the time slots in the schedule or routine generated. The descriptors (or keywords) may be generated based on the activities, events and other proclivities that may be occurring during a particular time slot identified by the analysis engine 103. The categorization and descriptors of each time slot may be useful to the campaign management system 121 for identifying the types of campaign notifications to deliver to the client device 101 and the most relevant or convenient times to deliver the campaign notifications in order to maximize the response elicited by the user viewing the campaign notification. Each time slot may include multiple categorizations, descriptors and/or key words to identify the activities, events, and occurrences happening within the time slot, including descriptors of participants and relationships of individuals who may be included in the events.

In some embodiments, the analytics engine 103 may include a tagging module 110. The tagging module 110 may perform the task of embedding metadata tags into data structure that has organized the user's schedule into time slots. For example, the tagging module 110 may insert metadata keywords into a table generated by the scheduling module 109. The metadata tags may include embedded keywords, descriptors and categorizations describing the events and occurrences occurring within the time slot as well as a descriptor of the times that the time slot encompasses. In some embodiments, users may add customized keywords and tags to the metadata in order to further customize the offers, promotions and other notifications generated by the campaign system 100. In some embodiments, the tagging module 110 may periodically update the tags and keywords of the time slots as a function of changes in the identified activities, events and conclusions provided by the analysis module 107 or scheduling module 109.

Embodiments of the analytics engine 103 may further include a reporting module 111. The reporting module 111 may be responsible for the performing the tasks of transmitting the schedule created by the scheduling module of the analytics engine 103 over a computer network 120 to the campaign management system 121. Prior to transmission of the schedule, in some embodiments, the reporting module 111 may digitally encode and/or compress the data comprising the schedule. As shown in FIG. 1, the client device 101 may be connected to a network 120 via wired or wireless hardware connections. As shown in the exemplary embodiment, the client device 101 may connect to the network 120 using a network interface controller (NIC) 119. Embodiments of the NIC may implement specialized electronic circuitry allowing for communication using a specific physical layer and data link layer standard such as Ethernet, Fibre channel, Wi-Fi or Token Ring. The NIC 119 may further allow for a full network protocol stack, enabling communication over network 120 to a group of computer systems or other computing hardware devices linked together through communication channels. The network 120 may facilitate communication and resource sharing among the computer systems 101, 121, 131 as well as network accessible hardware devices. Examples of network 120 may include a local area network (LAN), home area network (HAN), wide area network (WAN), back bone networks (BBN), peer to peer networks (P2P), campus networks, enterprise networks, the Internet, cloud computing networks and any other network known by a person skilled in the art.

Embodiments of the schedule generated by the analytics engine 103 may be loaded into the memory device 115 of the client device 101 via the reporting module 111. Once loaded into the memory device 115, the generated schedule may be transmitted by the NIC 119 over network 120 to a second specialized computer system 121, the campaign management system 121. In some embodiments, the campaign management system 121 may be an ad server, specially configured for serving advertisements and promotions for one or more marketing campaigns affiliated with the advertisements and promotions. Embodiments of the campaign management system 121 may receive the schedule generated by analytics engine 103 via NIC 219 which may receive the data of the schedule having the segmented time slots organized by category, activity, proclivity, etc. transmitted from client device 101. Embodiments of the transmitted schedule may be loaded into memory device 215 of the campaign management system 121 and subsequently decoded or decompressed by the campaign management system 215 in some embodiments.

In some embodiments of the targeted delivery system 100, the campaign management system 121 may include a separate analytics engine 123 from the analytics engine 103 of the client device 101. The analytics engine 123 of the campaign management system, may further analyze the segmented schedule and the corresponding scheduling data 209 received from client device 101. Unlike the analytics engine 103, which may collect, organize and categorize the user's activity information into the segmented schedule having a plurality of time slots, the campaign module 125 of the analytics engine 123 may compare each of the time slots of the schedule, the keyword descriptors and the metadata tags with the campaign notifications stored by the campaign notification database 129. Embodiments of the campaign notification database 129 may organize, tag and categorize each of the campaign notifications stored therein which may be available for distribution to the client device 101. The campaign module 125 may perform the action of querying the campaign notification database 129 for each time slot of the generated schedule loaded in memory device 215. As a function of the query, the campaign module 125 may retrieve the corresponding query results and associate on one or more campaign notifications with each of the time slot and schedule a period of time to transmit the content of the selected campaign notifications to the client device 101 via the network 120.

For example, the generated schedule may identify a time slot from 6:30 am to 7:30 am, wherein the user is getting ready for and commuting to work. The analytics engine 103 may have previously identified that during the morning commute, the user often drives a vehicle, listens to music and stops for coffee/breakfast. The scheduling module 109 and the tagging module 110 may have tagged the time slot from 6:30 am-7:30 am with keywords and descriptors relating to, the actions performed during the timeslot such as vehicle repairs/services, music streaming services, music delivery devices, advertisements for new forms of music, as well as restaurants and cafes located along the route of the user's commute. The campaign module may subsequently identify each of the campaign notifications stored in the campaign notification database 129, relevant to the keywords identifying a particular time slot and queue the campaign management system 121 with a list of campaign notifications relevant to the time slot.

In some embodiments, the campaign module 125 may identify each of the relevant campaign notifications for one or more of the time slots of the daily schedule. The campaign module 125 may generate a list of the campaign notifications to be delivered to the client device 101 and the time slots the contents of each campaign notification may be transmitted to the client device 101. The request module 127 of the campaign management 121 system may perform the task of transmitting remote procedure calls over network 120 to a content delivery system 131. In one embodiment, the remote procedure call may be made once the current time of day matches one of the time slots of the user's daily schedule where an activity or event occurs that bears some relevance to the campaign notification scheduled to be provided to the client device 101. Embodiments of content delivery system 131 may receive the remote procedure calls via the NIC 319 that has been transmitted by the campaign management system. In some embodiments, the content delivery system 131 may be a content distribution network (CDN) capable of serving the actual images, content and graphical data to the client device 101 for display on display device 114.

In some embodiments of the campaign system 100, the content delivery system 131 may load in the memory device 315, a content engine 132 which may collect and retrieve the contents of the campaign notification, such as the graphical data that may form the campaign notifications. The content delivery system 132 may store the graphical data and content of the campaign notifications in a content data store 137, data mart, or other organized data storage structure. Embodiments of the content engine 132 may include a retrieval module 133. The retrieval module 133 may be tasked with retrieving the content from the content data store 137 in accordance to the remote procedure call of the campaign management system 121, specifying the campaign notification and time slot to deliver the campaign notification to the client device 101. In accordance with the remote procedure call, the retrieval module may load the content of the campaign notification into memory device 315 while the delivery module 135 may transmit the content loaded in the memory device 315 via NIC 319 over network 120 to client device 101. The reporting module 111 may display the content of the campaign notification received from the content delivery system 131 as a graphical representation on display device 114.

### Method for Delivering Targeted Campaign Notifications

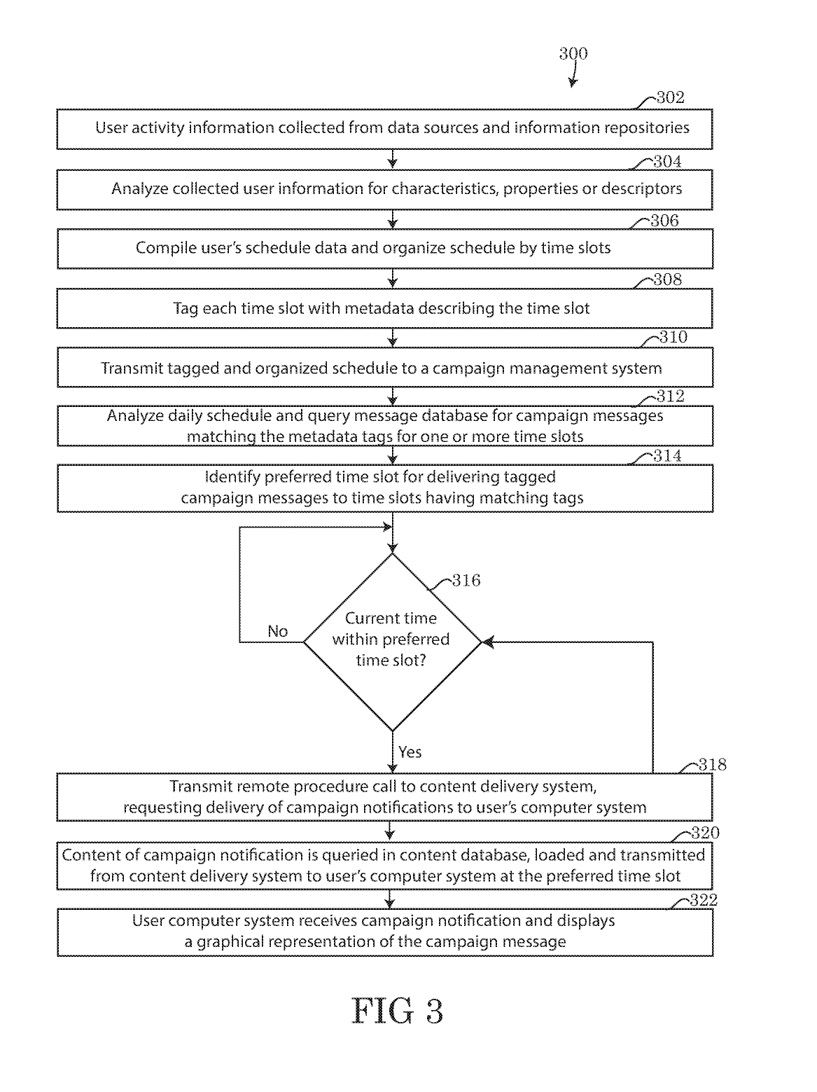

The drawing of FIG. 3 represents an embodiment of a method or algorithm that may be implemented for delivering targeted campaign notifications to a client device in accordance with the targeted campaign delivery systems 100 described in FIGS. 1-2b using one or more computers 101, 121, 131, 400 as defined generically in FIG. 4 below, and more specifically by the embodiments of FIGS. 1-2b. A person skilled in the art should recognize that the steps of the algorithm described in FIG. 3 may be performed in a different order than presented by FIG. 3 and the algorithm may not require all of the steps described herein to be performed. Rather some embodiments may deliver targeted campaign notifications using only one or more of the steps discussed below.

The embodiment of the method 300 for delivering targeted campaign notifications to the client device 101 may begin at step 302. In step 302, the data collection module 105 of the analytics engine 103 may collect user activity information 241 from a plurality of data sources 141, local data repositories 113, network repositories 139 and other organizational data structures available both locally to the client device 101 or remotely through network 120. The user activity information 241 collected by the data collection module 105 may be analyzed in step 304 of the method 300 by the analysis module 107. During the analysis by the analysis module 107, the analytics engine 103 may be analyzing the user activity information 241 for various characteristics, events, properties and descriptive information that may provide insight into the user's daily or regular routine. The analysis module 107 may identify patterns in behavior and routines performed by the user as a result of the analysis step 304.

Subsequently, in some embodiments of the method 300, in step 306 the system 100 may compile the user's schedule data and organize the schedule data into one or more discrete time slots. In the exemplary embodiment, the scheduling module 109 of the analytics engine 103 may compile a schedule of the user based on the analysis performed by the analysis module 105. The daily schedule may be organized into discrete time slots, where each time slot may be relevant to a particular event, activity, proclivity, behavior that the user may engage in during the user's daily routine. The scheduling module 109 may associate various keywords, descriptors, titles or other language describing each time slot and the events that may be known to occur as a result of the conclusions drawn by the analysis module 109.

In some embodiments, the tagging module 110 may, in step 308 of method 300, tag each time slot of the schedule organized in step 306 by inserting metadata into the file(s) comprising the generated schedule. The metadata describing each of the time slots may include keywords, descriptors and other identifying language that may provide insight into the events that may occur during the particular time slot. The metadata may provide other computer systems 101, 121, 131 with searchable parameters or keywords to compare the time slot with organized/tagged campaign notifications which may be stored by a campaign database 129. The system 100 to may use the tagged keywords and descriptors to select and deliver campaign notifications bearing the similar or the same keywords and descriptors as the events occurring in the time slots during the specific time slot identified by the analysis module 107.

In step 310 of the method 300, the tagged schedule that has been organized into a plurality of time slots and associated keywords/descriptors, may be transmitted over network 120 to the campaign management system 121. The tagged schedule may be loaded into the memory device 215 of the campaign management system 121. The contents of the tagged and organized schedule may be loaded into analytics engine 123. In step 312, of the method 300, the campaign module 125 may receive tagged schedule transmitted from the client device 101. The campaign module 125 may further analyze the daily schedule by querying campaign notification database 129 for appropriately similar or relevant campaign notifications to deliver at each schedule specific time slot. The query may retrieve from the database, a searchable list of one or more campaign notification available to the campaign management system 121 for delivery to client device 101. The campaign module 125 may proceed to match the metadata tags and keyword descriptors describing the time slots of the user's schedule with campaign notifications tagged with similar descriptors and key words.

In step 314 of method 300, the campaign module 125 may identify a preferred time slot for delivering each of the tagged campaign notifications. The preferred time slot may be the time that may most closely correspond to the events or activities occurring during a particular time slot matching the keywords or tags of the selected campaign notifications of step 312. In alternative embodiments, the preferred time slot may be a portion of the day wherein the user may have free time and thus may be available to receive, review and contemplate the campaign notification received. Step 314 may determine and finalize a time frame for delivering the content of the campaign notifications selected from the campaign notification database 129. In step 316, the request module 127 may implement the timing and agenda set by the campaign module 125 for delivering campaign notifications during a targeted time slot.

The request module 127 may make a determination in step 316 of whether the current time matches the preferred time slot for delivering the targeted campaign notification. If, the preferred time for scheduling the delivery of the campaign notification does not match the current time, the request module 127 may continue to wait, before transmitting a request to the content delivery system 131 to deliver the campaign notification to client device 101. If, however, the current time matches the preferred time slot for delivering the targeted campaign notification, the method 300 may proceed to step 318. During step 318, the request module 127 may transmit a remote procedure call (RPC) to the content delivery system 131. The RPC may identify the content being delivered to the client device 101, the timing for delivery the content and identification of the campaign notification currently stored by the content system's data store 137 that is requested for delivery to the client device 101.

In step 320 of the method, the RPC transmitted from the campaign management system 121 may be received by the content delivery system 131. The content of the campaign notification which may be the subject of the RPC may be queried in the content delivery system's data store 137. The query return may identify the content requested. The content of the desired notifications may be loaded into memory device 315 and transmitted over network 120 to the client device 101. Client device 101 may load the received content in memory device 115. In step 322, the client device 101 may display the contents of the campaign notification received by the content delivery system 131. In some embodiments, the contents of the campaign notification may be provided as graphical data that may be displayed by a display device 114 as a graphical representation of the campaign notification. The contents being displayed by the client device 101 may be provided as an alert, push notification, application notification, web advertisement or any other type of notification that may be displayed by a campaign system.

### Computer System

Referring to the drawings, FIG. 4 illustrates a block diagram of a computer system 400 that may be included in the systems of FIGS. 1-2 and for implementing methods for delivering targeted campaign notifications as shown in the embodiment of FIG. 3 and in accordance with the embodiments of the present disclosure. The computer system 400 may generally comprise a processor, otherwise referred to as a central processing unit (CPU) 491, an input device 492 coupled to the processor 491, an output device 493 coupled to the processor 491, and memory devices 494 and 495 each coupled to the processor 491. The input device 492, output device 493 and memory devices 494, 495 may each be coupled to the processor 491 via a bus. Processor 491 may perform computations and control the functions of computer 400, including executing instructions included in the computer code 497 for tools and programs for delivering targeted campaign notifications, in the manner prescribed by the embodiments of the disclosure using the systems of FIGS. 1-2, wherein the instructions of the computer code 497 may be executed by processor 491 via memory device 495. The computer code 497 may include software or program instructions that may implement one or more algorithms for implementing the methods for delivering targeted campaign notifications, as described in detail above. The processor 491 executes the computer code 497. Processor 491 may include a single processing unit, or may be distributed across one or more processing units in one or more locations (e.g., on a client and server).

The memory device 494 may include input data 496. The input data 496 includes any inputs required by the computer code 497. The output device 493 displays output from the computer code 497. Either or both memory devices 494 and 495 may be used as a computer usable storage medium (or program storage device) having a computer readable program embodied therein and/or having other data stored therein, wherein the computer readable program comprises the computer code 497. Generally, a computer program product (or, alternatively, an article of manufacture) of the computer system 400 may comprise said computer usable storage medium (or said program storage device).

Memory devices 494, 495 include any known computer readable storage medium, including those described in detail below. In one embodiment, cache memory elements of memory devices 494, 495 may provide temporary storage of at least some program code (e.g., computer code 497) in order to reduce the number of times code must be retrieved from bulk storage while instructions of the computer code 497 are executed. Moreover, similar to processor 491, memory devices 494, 495 may reside at a single physical location, including one or more types of data storage, or be distributed across a plurality of physical systems in various forms. Further, memory devices 494, 495 can include data distributed across, for example, a local area network (LAN) or a wide area network (WAN). Further, memory devices 494, 495 may include an operating system (not shown) and may include other systems not shown in FIGS. 12.

In some embodiments, the computer system 400 may further be coupled to an Input/output (I/O) interface and a computer data storage unit. An I/O interface may include any system for exchanging information to or from an input device 492 or output device 493. The input device 492 may be, inter alia, a keyboard, a mouse, sensors, biometric input device, camera, timer, etc. The output device 493 may be, inter alia, a printer, a plotter, a display device (such as a computer screen or monitor), a magnetic tape, a removable hard disk, a floppy disk, etc. The memory devices 494 and 495 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 400, and may include any type of transmission link, including electrical, optical, wireless, etc.

An I/O interface may allow computer system 400 to store information (e.g., data or program instructions such as program code 497) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk).

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that campaign notifications to deploy or integrate computing infrastructure with respect to accessing content of a shared account. Thus, an embodiment of the present invention discloses a process for supporting computer infrastructure, where the process includes providing at least one support service for at least one of integrating, hosting, maintaining and deploying computer-readable code (e.g., program code 497) in a computer system (e.g., computer 400) including one or more processor(s) 491, wherein the processor(s) carry out instructions contained in the computer code 497 causing the computer system to deliver targeted campaign notifications. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method of accessing content of a shared account. Thus the present invention discloses a process for supporting, deploying and/or integrating computer infrastructure, integrating, hosting, maintaining, and deploying computer-readable code into the computer system 400, wherein the code in combination with the computer system 400 is capable of performing a method of delivering targeted campaign notifications.

A computer program product of the present invention comprises one or more computer readable hardware storage devices having computer readable program code stored therein, said program code containing instructions executable by one or more processors of a computer system to implement the methods of the present invention.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or obj ect code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for delivering targeted campaign notifications to a computer system comprising the steps of:
analyzing, by a processor of the computer system, user activity information received from a one or more data sources;
compiling, by the processor, as a function of the analyzing step, a schedule organized into time slots, wherein each of the time slots are categorized with a corresponding metadata tag describing properties of each of the time slots;
transmitting, by the processor, the schedule to a campaign management system;
receiving, by the processor, a campaign notification transmitted during a time slot of the schedule, wherein content of the campaign notification is selected by the campaign management system to match the metadata tag describing the properties of the time slot; and
displaying, by the processor, a graphical representation of the campaign notification during the time slot.

2. The method of claim 1, further comprising the steps of:
receiving, by the campaign management system, the schedule;
analyzing, by the campaign management system, the schedule for available campaign notifications that are categorized with the same metadata tag as each of the time slots; and
identifying, by the campaign management system, a preferred time slot to deliver the campaign notification that matches the metadata tag, wherein the preferred time slot is the time slot having a highest probability of the campaign notification being observed by a user.

3. The method of claim 2, further comprising the steps of:
transmitting, by the campaign management system, a remote procedure call (RPC) to an content delivery system, wherein the RPC directs the content delivery system to transmit the campaign notification to the computer system within the preferred time slot.

4. The method of claim 1, wherein the metadata tag describing the properties of the time slot is descriptive metadata identifying activities performed by a user during the time slot.

5. The method of claim 1, wherein the metadata tag describing the properties of the time slot identifies the time slot with a descriptor selected from the group consisting of free time, working and leisure time.

6. The method of claim 3, wherein the campaign management server is an ad server hosting a marketing campaign, and the content delivery system is a content delivery network (CDN) hosting the graphical representation of the campaign notification displayed by the processor of the computer system.

7. The method of claim 1, wherein the campaign notification is integrated and displayed as a section of a website, application or web application.

8. The method of claim 1, further comprising providing at least one support service for at least one of creating, integrating, hosting, maintaining, and deploying computer-readable program code in a computer system, where the computer-readable program code in combination with the computer system is configured to implement the steps of analyzing, compiling, transmitting, receiving and displaying.

9. A computer system, comprising:
a central processing unit (CPU);
a memory device coupled to the CPU; and
a computer readable storage device coupled to the processor, wherein the storage device contains program code executable by the CPU via the memory device to implement a method for delivering targeted campaign notifications to the computer system comprising the steps of:
analyzing, by the CPU, user activity information received from a plurality of data sources;
compiling, by the CPU, as a function of the analyzing step, a schedule organized into discrete time slots, wherein each of the time slots are categorized with a corresponding metadata tag describing properties of each of the time slots;
transmitting, by the CPU, the schedule to a campaign management system;
receiving, by the CPU, a campaign notification transmitted during a time slot of the schedule, wherein content of the campaign notification is selected by the campaign management system to match the metadata tag describing the properties of the time slot; and
displaying, by the CPU, a graphical representation of the campaign notification during the time slot.

10. The system of claim 9, further comprising the steps of:
receiving, by the campaign management system, the schedule;
analyzing, by the campaign management system, the schedule for available campaign notifications that are categorized with the same metadata tag as each of the time slots; and
identifying, by the campaign management system, a preferred time slot to deliver the campaign notification matched to the metadata tag, wherein the preferred time slot is the time slot having a highest probability of the campaign notification being accepted.

11. The system of claim 10, further comprising the steps of:
transmitting, by the campaign management system, a remote procedure call (RPC) to an campaign notification delivery system, wherein the RPC directs the campaign notification delivery system to transmit the campaign notification to the computer system within the preferred time slot.

12. The system of claim 10, wherein the metadata tag describing the properties of the time slot is descriptive metadata identifying activities performed by a user during the time slot.

13. The system of claim 9, wherein the metadata tag describing the properties of the time slot identifies the time slot as free time.

14. The system of claim 11, further comprising the step of:
wherein the campaign management server is an ad server hosting a marketing campaign, and the campaign notification delivery system is a content delivery network (CDN) hosting the graphical representation of the campaign notification displayed by the processor of the computer system.

15. A computer program product comprising:
one or more computer readable hardware storage devices having computer readable program code stored therein, said program code containing instructions executable by the one or more central processing units (CPU) to implement a method for delivering targeted campaign notifications to a computer system comprising the steps of:
analyzing, by the CPU, user activity information received from a plurality of data sources;
compiling, by the CPU, as a function of the analyzing step, a schedule organized into discrete time slots, wherein each of the time slots are categorized with a corresponding metadata tag describing properties of each of the time slots;
transmitting, by the CPU, the schedule to a campaign management system;
receiving, by the CPU, a campaign notification transmitted during a time slot of the schedule, wherein content of the campaign notification is selected by the campaign management system to match the metadata tag describing the properties of the time slot; and
displaying, by the CPU, a graphical representation of the campaign notification during the time slot.

16. The computer program product of claim 15, further comprising the steps of:
receiving, by the campaign management system, the schedule;
analyzing, by the campaign management system, the schedule for available campaign notifications that are categorized with the same metadata tag as each of the time slots; and
identifying, by the campaign management system, a preferred time slot to deliver the campaign notification matched to the metadata tag, wherein the preferred time slot is the time slot having a highest probability of the campaign notification being accepted.

17. The computer program product of claim 16, further comprising the steps of:
transmitting, by the campaign management system, a remote procedure call (RPC) to an campaign notification delivery system, wherein the RPC directs the campaign notification delivery system to transmit the campaign notification to the computer system within the preferred time slot.

18. The computer program product of claim 15, wherein the metadata tag describing the properties of the time slot is descriptive metadata identifying activities performed by a user during the time slot.

19. The computer program product of claim 15, wherein the metadata tag describing the properties of the time slot identifies the time slot as free time.

20. The computer program product of claim 17, wherein the campaign management server is an ad server hosting an campaign notification's marketing campaign, and the campaign notification delivery system is a content delivery network (CDN) hosting the graphical representation of the campaign notification displayed by the processor of the computer system.
